(19) United States
(12) Patent Application Publication
(10) Pub. No.: US 2024/0083477 A1
(43) Pub. Date: Mar. 14, 2024

(54) RAIL SENSOR UNIT

(71) Applicant: DSRailTech, a.s., Nové Mesto (Praha 2) (CZ)

(72) Inventors: José Arturo LOZANO ANGULO, Praha - Dejvice (CZ); Ladislav SMATANA, Stúrovo (SK); Richard STEC, Kosice (SK); Samuel KUPKA, Kosice (SK); Jaroslav GALLO, Kosice (SK); Pavol AMRICH, Kosice (SK)

(73) Assignee: DSRailTech, a.s., Nové Mesto (Praha 2) (CZ)

(21) Appl. No.: 18/263,470

(22) PCT Filed: Feb. 9, 2021
(86) PCT No.: PCT/EP2021/053067

§ 371 Date: Jul. 28, 2023

(51) Int. Cl. B61L 1/06; B61L 1/02

(52) U.S. Cl. CPC B61L 1/06; B61L 1/025

(57) ABSTRACT

A rail sensor unit (10) for attachment to a rail (12) of a rail track, and for sensing by attachment to the rail, acoustic signals and vibrations in the rail. The sensor unit (10) comprises a housing body (20) made in one piece, having a contoured sensing wall portion (22), and an interior compartment (24). The contour is tailored for fitting against a head, web or foot of a rail. At least one piezo-electric transducer (42) within the housing body (20) is coupled to the sensing wall portion (22) for sensing acoustic signals. The housing body (20) efficiently provides substantially all of the contact surfaces form-fitting to the rail. Electronic circuitry (52) in the housing has a controllable dynamic range configuration for both weak signal detection and strong signal detection. The electronic circuitry and electromagnetic shielding protection (48a, 50a) are mounted on a rigid-flex printed circuit substrate (46) folded in the interior compartment (24).

### FIELD OF THE DISCLOSURE

The present disclosure relates to the field of sensor units for attachment to a rail of a rail track, for example, a railway rail or a tram rail.

### BACKGROUND TO THE DISCLOSURE

Rail sensor units attached to rail tracks are used in electronic monitoring systems for monitoring rail traffic and rail conditions. The sensor unit may sense signals directly from the rail for processing by the electronic monitoring system. For example, the sensor unit may detect acoustic vibrations transmitted through the rail, especially by a passing train.

Designing such sensor units remains a technical challenge. It is difficult to meet the conflicting requirements of low-cost, high signal sensitivity, reliable operation, and good electromagnetic compatibility (EMC), while meeting the requirements for small physical dimensions and placement of the sensor on the rail and also being able to endure the extremely harsh physical, vibrationary, weather and electrical environment of a rail installation.

A representative example of rail sensor unit is described in WO 2019/076993. The unit comprises an acoustic vibration detector mounted in a box attachable to the rail. The box has two parts, a lower housing and an upper cover. The upper cover carries the acoustic detector and fits against the upper flange or head of the rail profile, for receiving acoustic vibrations from that part of the rail. Different covers, with different shapes, are said to be selectable to adapt to the rail profile. The lower housing carries a main fixation magnet on its face facing the web of the rail profile, and contains electronic circuitry for digitising the output signal from the acoustic detector in the cover, and processing the digitised signal. The circuitry comprises an on-board monitoring system for detecting events or situations locally from the acoustic signals. The lower housing is divided into three separate compartments by fixed partition walls. The compartments provide electromagnetic shielding for the sensor, separating different parts of the system, reducing stray signals and electromagnetic interference.

Another representative example of rail sensor unit is described in WO 2012/036565. The unit comprises a housing having two compartments for electromagnetic shielding. An acoustic vibration detector and amplifier are disposed in one compartment next to the sidewall of a head of a rail profile. Feed-through capacitors connect through the compartment wall to feed the detected signal into the second compartment also disposed adjacent to the head of the rail.

### SUMMARY OF THE DISCLOSURE

It would be desirable to address and/or mitigate one or more of the technical challenges described above.

Aspects of the invention are defined in the claims.

Additionally or alternatively, in a first aspect, a rail sensor unit is provided for attachment to a rail of a rail track. The sensor unit is configured for sensing, by attachment to the rail, at least one physical parameter associated with objects interacting mechanically with the rail. The sensor unit comprises a housing comprising a housing body made in one piece. The housing body has a sensing wall portion and an interior compartment defined at least partly by the sensing wall portion. The sensing wall portion of the housing body comprises a contoured contact surface for fitting against at least a portion of a rail profile. The sensor unit further comprises a transducer in the interior compartment of the housing body and coupled to the sensing wall portion of housing body for sensing the parameter transmitted to the sensor unit through physical attachment of the housing to the rail. The sensor unit further comprises electronic processing circuitry in the interior compartment of the housing body for processing a signal from the transducer.

As used herein, the term “physical parameter” refers to a parameter that may be sensed directly by the transducer (for example, but not limited to: acoustic signals; and/or vibrations; and/or rail displacement). The physical parameter is associated with objects interacting mechanically with the rail, whether directly or indirectly. Mechanical interaction refers to interaction relating to physical forces or motion. Mechanical interaction includes at least: objects (e.g. trains, trams, metros, or other rolling stock) moving on the rail or track; and/or objects (e.g. rocks, landslides, trees or other obstructions) falling against or near the rail or track, creating impact vibrations detectable in the rail.

The transducer may be or comprise one or more selected from: an acoustic sensor; a piezo-electric sensor; an accelerometer; a vibration sensor. Plural transducers of the same type (e.g. plural piezo-electric transducers and/or plural accelerometers, e.g. also unidirectional accelerometers and/or 3D accelerometers) and/or plural transducers of different types (e.g. at least one piezo-electric transducer and at least one accelerometer) may be provided within the housing. For the avoidance of doubt, references herein to “first” and “second”, such as first and second transducers, are not limited only to two, but encompass any plurality or at least two.

Also as used herein, the term “contoured contact surface” refers to a surface that is at least partly non-flat. By way of example, the contour may be configured for fitting against one or more of: a head of a rail profile; a web of a rail profile; a foot of a rail profile.

The above arrangement can achieve high coupling efficiency between the rail and the transducer for the signals desired to be detected. Coupling efficiency is important, because it directly affects the sensitivity of the sensor unit, in other words, the ability to detect even weak signals in the rail. The contour of the sensing wall portion may permit the contact surface to make an at least approximate form fit against the portion of the rail it is configured to fit, and preferably a close or intimate form fit. Such a contour may further enhance the coupling between the head of the rail and the first body. Making the housing body in one piece can avoid reduced coupling efficiency at joints between different pieces that contact the rail separately. Making the housing body in one piece can simplify the assembly process for the sensor unit as a whole. Making the housing body in one piece can also make the unit more cost efficient than an equivalent body made in several pieces that have to be attached together to form the contact surface with the rail.

Detection of the physical parameter by the sensor may enable monitoring of many types of activity and/or objects and/or impacts on the track. For example, activity may include approach of rolling stock (e.g. train, tram, metro or other vehicle) on the track, and/or detection as the different parts of the rolling stock pass over the sensor unit, and/or movement away down the track. However, good sensitivity to signal detail and/or weak signals can enable the information generated by the sensor to be processed on-unit and/or off-unit, to monitor conditions and/or detect activity occurring even at a distance from the sensor unit, such as one or more of: (i) track conditions (e.g. a state of the rail); and/or (ii) rolling stock operating conditions; and/or (iii) objects (e.g. rocks or trees) falling on to the track; and/or (iv) movement of animals and/or people near or on the track; and/or (v) cutting of cables near the track; and/or (vi) cutting of a rail (e.g. theft or sabotage).

The housing body may optionally have an open extremity, for example, opposite the sensing wall portion. Additionally or alternatively, the housing body may have an elongate tub shape. The tub shape may comprise the sensing wall portion, at least two side elongate side walls extending (e.g. depending) from the sensing wall portion opposite one another, and at least two end walls extending (e.g. depending) from the sensing wall portion.

The housing may optionally comprise a further element, such as a cover (e.g. a bottom cover), for closing over the open extremity of the housing body (e.g. a lower extremity). However, the single-piece construction of the housing body can provide good coupling efficiency with the rail and cost-effective construction, whether or not additional elements are also present.

In some examples, the contoured surface of the upper wall portion may comprise a shoulder (e.g. in the form of a plateau) and a ridge upstanding from the shoulder, e.g. at an edge of the shoulder. The shoulder may, for example, be configured for fitting against the underside of an undercut of a rail profile head. The upstanding ridge may, for example, be configured for fitting against a lateral edge of the head. The ridge may, for example, have a surface that is inclined or bevelled with respect to the shoulder.

The above contour may be configured for fitting against a head of a rail profile. Other contour shapes may be used for fitting against a web or a foot of a rail profile. For example, the contoured contact surface may comprise one or more of: a generally symmetric convex surface; a generally asymmetric convex surface; a convex surface having a maximum height difference across the surface of no more than 30 mm; a surface having a non-square edge profile along at least one edge, the non-square profile selected from bevelled, chamfered, rounded.

The sensor unit may further comprise at least a first magnet, optionally first and second magnets, positioned within the interior compartment of the housing body adjacent to the sensing wall portion for magnetically attracting the housing to a rail via the sensing wall portion. In some examples, the sensor unit may be attached to the rail by adhesive, the magnetic attraction serving to reinforce the adhesive and/or stabilize the sensor unit on the rail while the adhesive cures. Additionally or alternatively to adhesive, a clamp may be used to attach the sensor unit to the rail, the magnetic attraction serving to reinforce the attachment. Alternatively, the magnetic attraction may be the primary and/or only attachment of the sensor unit to the rail.

The housing body may optionally comprise a side contact surface for facing towards and/or fitting against the web of the rail. A junction between the shoulder and the side contact surface may have a non-square shape. The non-square shape may, for example, be selected from bevelled, chamfered, rounded.

Optionally, the side contact surface may augment the size of the contact area between the rail and the housing body, by providing a surface for fitting against the web of the rail. Additionally or alternatively, the non-square shape of the junction between the shoulder and the side contact surface may provide an at least approximate form fit to the profile of the rail at the point where the web meets the head.

In some embodiments, the contact surface of the upper wall portion may provide at least 60%, optionally at least 70%, optionally at least 80%, optionally at least 90%, of the contact surface between the housing and the head of the rail.

Additionally or alternatively, in some embodiments, the side contact surface of the housing body may provide at least 60%, optionally at least 70%, optionally at least 80%, optionally at least 90%, of the contact surface between the housing and the web of the rail.

Additionally or alternatively, in some embodiments, the contact surface of the upper wall portion, and the side contact surface provide, collectively, at least 60%, optionally at least 70%, optionally at least 80%, optionally at least 90%, of the contact surface of the housing for contacting the rail.

A large contact area can increase the degree of coupling and transmission of signals from the rail into the housing body and to the transducer. With the above arrangement, the contact surface(s) of the housing body can provide at least a majority of the contact surface of the housing as a whole, for fitting against the head and/or web and/or foot. Thus a large proportion of the contact surface, optionally substantially all of the contact surface, is utilised for transmitting signals from the rail into the housing body and to the transducer.

The transducer may be coupled to the housing body directly, or through one or more intermediate elements. In some embodiments, the transducer is attached (e.g. glued) to a portion of an electromagnetic shield which in turn is attached (e.g. glued) to the housing body. The position of attachment of the transducer to the electromagnetic shield may optionally be on an opposite face to, and/or generally opposite, the position of attachment of the shield to the upper wall portion of the housing body to facilitate close coupling between the transducer and the upper wall portion.

A closely related second aspect provides a rail sensor unit, optionally according to the first aspect, for attachment to a rail of a rail track, the rail having at least a head and a web in profile. The sensor unit is configured for sensing, by attachment to the rail, at least one physical parameter associated with objects interacting mechanically with the rail. The sensor unit comprises a housing having contact surface portions for contacting the rail head and rail web. The housing comprising a housing body made in one piece. The housing body has an upper wall with a first contact surface for fitting against the rail head, and providing at least a majority of the contact surface portion of the housing for fitting against the rail head. The housing body further comprises a side wall with a second contact surface for fitting against the rail web, and providing at least a majority of the contact surface of the housing for fitting against the rail web. The housing contains at least one transducer coupled to the housing body for sensing the parameter transmitted to the sensor unit through physical attachment of the housing to a rail.

In a similar manner to that discussed above, a large contact area can increase the degree of coupling and transmission of signals from the rail into the housing body and to the transducer. With the above arrangement, the contact surface(s) of the housing body can provide at least a majority of the contact surface of the housing as a whole, for fitting against the web and/or head. Thus a large proportion of the contact surface is utilised for transmitting signals from the rail into the housing body and to the transducer.

In some embodiments, the first contact surface of the housing body may provide at least 60%, optionally at least 70%, optionally at least 80%, optionally at least 90%, of the contact surface between the housing and the head of the rail.

Additionally or alternatively, in some embodiments, the second contact surface of the housing body may provide at least 60%, optionally at least 70%, optionally at least 80%, optionally at least 90%, of the contact surface between the housing and the web of the rail.

Additionally or alternatively, in some embodiments, the first and second contact surfaces of the housing body provide, collectively, at least 60%, optionally at least 70%, optionally at least 80%, optionally at least 90%, of the contact surface of the housing for contacting the rail.

A closely related third aspect provides a rail sensor unit, optionally including any of the features of the first and/or second aspect described above, for attachment to a rail of a rail track, for sensing by physical attachment to the rail at least one physical parameter associated with objects interacting mechanically with the rail. The sensor comprises a housing, at least one transducer within the housing for sensing the parameter transmitted to the rail sensor through physical attachment to the rail, and electronic circuitry within the housing for receiving a signal from the at least one transducer. The electronic circuitry has a controllable dynamic range configuration settable in at least (i) a first configuration for handling relatively a weak occurrence of the physical parameter to be sensed by the at least one transducer, and (ii) a second configuration for handling a relatively strong occurrence of the physical parameter to be sensed by the at least one transducer.

The electronic circuitry may further comprise a controller for dynamically switching between the dynamic range configurations.

Controlling the dynamic range configuration of the electronic circuitry in such a manner can address the problem of enabling good sensitivity for weak signals without overloading the circuitry for strong signals. The amplitude of signals detectable from the rail by the at least one transducer when a train is passing overhead can be 60000 times greater than the amplitude of signals detectable in the rail by the at least one transducer for more distant events. A circuit, and/or analog-to-digital converter (ADC), configured for high sensitivity to weak signals may quickly saturate for high amplitudes. Conversely, a circuit and/or ADC, configured for high amplitude signals may not have good sensitivity or resolution for discriminating weak signals compared to a noise floor. The technique disclosed herein can adapt the dynamic range configuration to suit the expected signal conditions.

This aspect may be used independently of the first and second aspects, but further advantages result in combining several aspects by benefitting from good coupling efficiency from the rail to the transducer. This can enhance detection of weak signals compared to prior techniques, and enhance the usefulness of the sensor by extending the rail distance from which useful signals can be observed, without the signal saturating when a train is near or overhead.

In some embodiments, the at least one transducer is a piezoelectric transducer. The transducer may detect acoustic signals and/or vibrations from the rail.

In some embodiments, the at least one transducer comprises first and second transducers generating first and second signals. The electronic circuitry may comprise first and second input channels for the first and second signals. Using first and second transducers may improve accuracy and signal-to-noise ratio, by being able to identify a useful common signal component from the transducers. Additionally or alternatively, using first and second transducers may provide failsafe redundancy between the transducers should one transducer suffer a technical failure.

In some embodiments, the first and second transducers have different sensitivities to the physical parameter. A first sensitivity of the first transducer may be greater than a second sensitivity of the second transducer. Using transducers of different sensitivity can enable generation of at least one signal of suitable output amplitude, whether the occurrence of the physical parameter in the rail is strong or weak. Optionally, the electronic circuitry is configured to select, for the first configuration, the first transducer or a signal derived therefrom, and to select, for the second configuration, the second transducer or a signal derived therefrom.

In some examples, the first and second transducers may be independent devices, for example, piezo-electric transducers with independent ceramic and/or crystal substrates. Alternatively, the first and second transducers may share one or more common elements. For example, first and second piezo-electric transducers may share a common ceramic substrate and/or a common crystal substrate and/or a common connection terminal to a substrate, but generate signals separately and/or independently of one another. In the case of piezo-electric transducers, optionally, sharing a common substrate, the sensitivity of the transducer may depend on the area of a signal and/or non-common electrode or terminal on the substrate. Different sensitivities may be engineered by selecting respective different area sizes. Alternatively, matching sensitivities may be engineered by matching the area sizes.

The electronic circuitry may be responsive to a magnitude of an envelope signal for controlling the dynamic range. The envelope signal may be generated from the output of the at least one transducer. Alternatively, the envelope signal may be generated from the output of a further transducer having different characteristics from the first-mentioned transducer(s). For example, the further transducer may sense a further physical parameter at least partially different from the first physical parameter and/or the further transducer may have a different response. In some embodiments, the further transducer is an accelerometer. The accelerometer may detect vibrations transmitted from the rail to the sensor unit indicative, for example, of a train approaching.

In some embodiments, the dynamic range configuration may be settable relatively quickly to the second configuration in response to the further sensor sensing a signal above a predetermined threshold (e.g. a switching threshold). The dynamic range configuration may remain in the second configuration at least while the further sensor senses a signal exceeding the threshold. Hysteresis may be used when determining when to switch the dynamic range configuration back to the first configuration. For example, the dynamic range configuration may (e.g. only) be switched back to the first configuration once the signal from the further sensor has dropped below the threshold and remains below the threshold for at least a predetermined interval (e.g. time interval). Switching of the dynamic range configuration from the first configuration to the second configuration may have a rapid response with respect to the (e.g. switching) threshold. Switching of the dynamic range configuration from the second configuration to the first configuration may have a slower and/or delayed response with respect to the (e.g. switching) threshold. Such a technique can ensure that the dynamic range configuration of the circuitry is set to the first configuration sensitive to relatively weak signals in the rail only when there is surety that strong signals are absent and/or not expected.

In some embodiments, the electronic circuitry comprises first and second amplifiers (or amplifier channels) having different signal gains. The electronic circuitry may select, for the first configuration, the first amplifier or a signal derived therefrom, and for the second configuration, the second amplifier or a signal derived therefrom. Alternatively, a signal amplifier may be provided having a controllable gain responsive to the dynamic range configuration, the gain being settable at a first relatively high gain corresponding to the first dynamic range configuration for handling a relatively weak signal, and a second relatively low gain corresponding to the second dynamic range configuration for handling a relatively strong signal.

A closely related aspect provides a method of operation in a rail sensor unit, optionally a rail sensor unit as described in any of the preceding aspects. The sensor unit may be configured for attachment to a rail of a rail track, for sensing by physical attachment to the rail at least one physical parameter associated with objects interacting mechanically with the rail. The sensor unit can comprise a housing, at least one transducer (e.g. a piezo-electric transducer) within the housing for sensing the physical parameter transmitted to the rail sensor through physical attachment to the rail, and electronic circuitry within the housing for receiving a signal from the at least one transducer. The method of this aspect comprises operating a controller to dynamically set a controllable dynamic range configuration of the electronic circuitry selectively between at least, optionally between exactly: (i) a first configuration for handling a relatively weak occurrence of the physical parameter to be sensed by the at least one transducer, and (ii) a second configuration for handling a relatively strong occurrence of the physical parameter to be sensed by the at least one transducer. At least the first and second configurations are provided, but more than two configurations may also be implemented to suit design requirements.

The at least one transducer may comprise a first transducer having a first sensitivity to the physical parameter, and a second transducer having a second sensitivity to the physical parameter smaller than the first sensitivity. The step of dynamically setting the controllable dynamic range configuration may comprise selecting, for the first configuration, the first transducer or a signal therefrom, and selecting, for the second configuration, the second transducer or a signal therefrom.

Additionally or alternatively, the electronic circuitry may comprise first and second amplifiers having respectively different gains. The step of dynamically setting the controllable dynamic range configuration may comprise selecting between the first and second amplifiers (or between signals derived therefrom). Alternatively, the electronic circuitry may optionally comprise an amplifier with a variable or settable gain characteristic, and the method step of dynamically setting the controllable dynamic range configuration may comprise setting a gain level of the amplifier.

The step of setting may comprise the step of setting the controllable dynamic range configuration in response to a signal from a further transducer (e.g. an accelerometer) for sensing a second physical parameter different from the first physical parameter or for sensing the first physical parameter differently from the first transducer.

The step of setting the controllable dynamic range configuration may optionally include hysteresis, such that transitioning from the first configuration to the second configuration occurs relatively rapidly in response to an expected strong signal, and transitioning from the second configuration to the first configuration occurs more slowly and/or with a delay in response to weak signal conditions.

A further aspect provides a rail sensor unit, optionally according to any of the aspects above, for attachment to a rail of a rail track, for sensing by physical attachment to the rail at least one parameter associated with objects interacting mechanically with the rail. The sensor unit comprises a housing, and a transducer within and coupled to the housing for sensing the parameter transmitted to the rail sensor through physical attachment to the rail. An at least partly flexible circuit substrate (e.g. a rigid-flex printed circuit board) within the housing has a first zone on which is mounted the transducer and first electronic circuitry for receiving a signal from the transducer, and a second zone on which is mounted second electronic circuitry for processing a signal after processing by the first electronic processing circuitry. The circuit substrate has a folded configuration within housing, optionally to stack the first and second zones within the interior space of the housing. Optionally, the first and second zones may be or include rigid portions of a rigid-flex substrate, separated by a flexible connection portion.

Such a construction using an at least partly flexible circuit substrate can combine (i) cost-effective production of the electronic circuitry on a common substrate, (ii) simplified assembly of the electronic circuitry to the housing, (iii) desired positioning of the transducer with respect to the housing, and (iv) economic use of the available space within the housing. A flexible portion of the circuit substrate may also be less vulnerable to stress accumulation when the sensor unit is subjected to extreme vibrations of a train passing overhead, compared to a non-flexible common substrate. The at least partly flexible circuit substrate may carry substantially all of the components of the first and second electronic circuitry, and optionally substantially all of the components of electrical circuitry of the sensor unit.

The first electronic circuitry may comprise a signal amplifier for amplifying an analog signal from the transducer. Providing a signal amplifier in the first zone can pre-amplify the signals locally close to the transducer, to enable the signals to be transmitted subsequently further away to the second circuitry in the second zone.

A signal from the first electronic circuitry may be transmitted to the second electronic circuitry via the circuit substrate. This can avoid the need for additional hard wiring and/or connection plugs and sockets for connecting different sections or compartments of the housing.

In some embodiments, the sensor unit further comprises first electromagnetic interference protection for electromagnetically shielding the first zone of the flexible circuit board, and second electromagnetic interference protection for electromagnetically shielding the second zone of the flexible circuit board. This can enable the sensor unit to be protected against receiving or emitting stray signals, without having to build special electromagnetic shielding walls or compartments into the construction of the housing. Again, this can reduce the cost of manufacture of the housing unit, and simplify assembly of the electronic circuitry to the housing.

A plurality of transducers may be mounted in the first zone of the flexible circuit substrate. For example, the transducers may be piezo-electric transducers.

The rail sensor of any of the preceding aspects may be defined independently, or optionally in combination with a rail to which the rail sensor is attached or intended to be attached.

Although the above description has focused on certain aspects of the disclosure, this is merely a non-limiting summary useful for understanding certain ideas and concepts described herein. Protection is claimed for any novel idea or feature described herein and/or illustrated in the drawings, whether or not emphasis has been placed thereon.

### BRIEF DESCRIPTION OF THE DRAWINGS

FIG. 1 is a schematic end view of a rail sensor unit, and depicting its attachment to a head of a rail profile;

FIG. 2 is a schematic perspective view from above of a first body of the housing of the sensor unit of FIG. 1;

FIG. 3 is a schematic perspective view from below of the first body of FIG. 2;

FIG. 4 is a schematic perspective view similar to FIG. 3 additionally showing magnets fitted to the housing;

FIG. 5 is a schematic side section of the sensor unit with a folded flexible circuit substrate;

FIG. 6 is a schematic view showing a layout of transducers and circuitry of the sensor unit on the circuit substrate, shown in an unfolded condition.

FIG. 7 is a schematic flow diagram of an algorithm for controlling the dynamic range and/or amplifier gain of circuitry of the sensor unit.

FIG. 8 is a schematic flow illustration depicting attachment of a rail sensor to a rail using a clamp.

FIG. 9 is a schematic illustration depicting attachment of a rail sensor unit to a web of a rail profile.

FIG. 10 is a schematic illustration depicting attachment of a rail sensor to a foot of a rail profile.

### DETAILED DESCRIPTION OF PREFERRED EMBODIMENTS

Non-limiting embodiments of the disclosure are now described, by way of example, with reference to the accompanying drawings. The same reference numerals are used to denote the same or equivalent features whether or not described in detail.

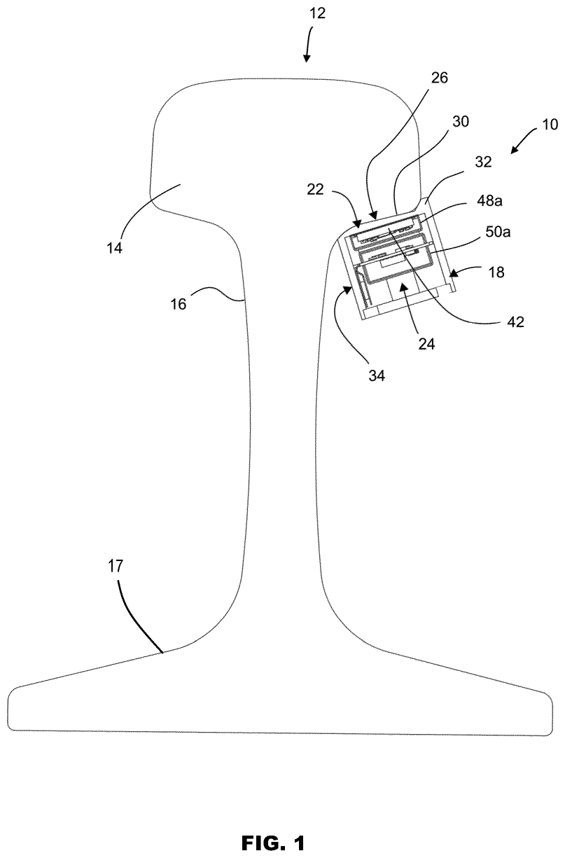

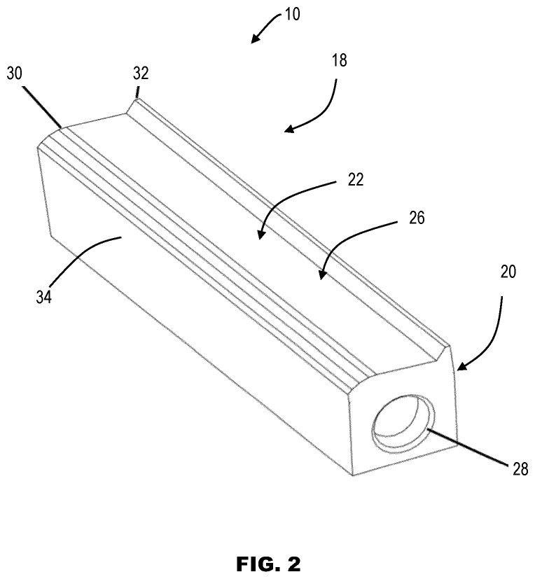

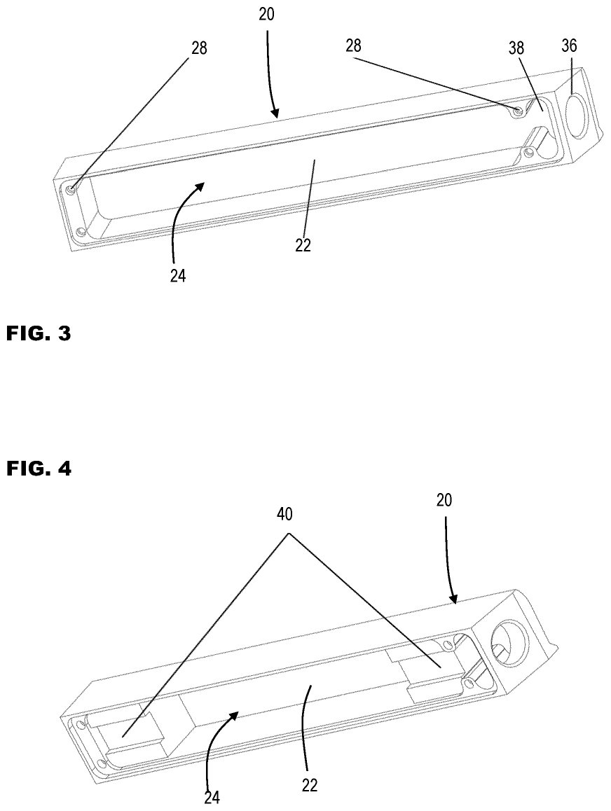

Referring to FIGS. 1-3, a rail sensor unit 10 is shown for attachment to a rail 12 of a rail track, for example, any of a railway rail, a tram rail, a metro rail, or any other transport rail. The rail 12 has one or more of: a head 14, a web 16, and a foot 17 in profile. The sensor unit 10 is configured for sensing, by attachment to the rail 12, at least one physical parameter associated with objects interacting mechanically with the rail. For example, the physical parameter may be acoustic signals and/or vibrations and/or rail displacement.

The sensor unit 10 comprises a housing 18 comprising a housing body 20 made in one piece. The housing body 20 has a sensing wall portion 22 which, in this example corresponds to an upper wall portion. The housing body 20 also has an interior compartment 24 defined at least partly by the sensing wall portion 22. The sensing wall portion 22 has a contoured contact surface 26 for fitting against a predetermined part of the rail profile. The contour of the sensing wall portion 22 and/or the contact surface 26 may permit the contact surface 26 to make an at least approximate form fit, and optionally a close or intimate form fit, against the respective part of the profile of the rail 12, for efficient coupling of signals from the rail 12 into the housing body 20, and to assist in positively locating and maintaining the sensor unit 10 in alignment with the rail 12.

In the illustrated form for fitting against the rail head 14, the sensing (upper) wall portion 22 and/or its contact surface 26 comprises a shoulder 30 and a ridge 32 upstanding from an edge of the shoulder 30. The shoulder 30 may be generally flat, for example, in the form of a plateau, or it may be further contoured. The ridge 32 may have an inclined or bevelled configuration with respect to the shoulder 30. In use, the shoulder 30 may be configured to fit against the underside of an undercut of the rail head 14. The ridge 32 may be configured for fitting against a side edge of the rail head 14.

The contact surface 26 of the sensing wall portion 22 may provide at least a majority, optionally at least 60%, optionally at least 70%, optionally at least 80%, optionally at least 90% of the contact portion of the entire housing 18 for contacting the rail head 14.

The housing body 20 may further comprise at least a side contact wall 34 having a contact surface for fitting against and/or facing towards the rail web 16. A junction between the shoulder 30 and the side contact wall 34 may have a non-square shape, for example, a rounded, bevelled or chamfered shape. The configuration may enable the housing body 20 to have an at least approximate form fit with the rail 12 at a point where the rail head 14 meets the rail web 16. Additionally or alternatively, the side contact wall 34 may extend the region of contact between the housing body 20 and the rail 12, to further enhance coupling efficiency for the signal to be detected. The side wall 34 may provide at least a majority, optionally at least 60%, optionally at least 70%, optionally at least 80%, optionally at least 90%, of the contact portion of the entire housing 18 for contacting the rail web 16.

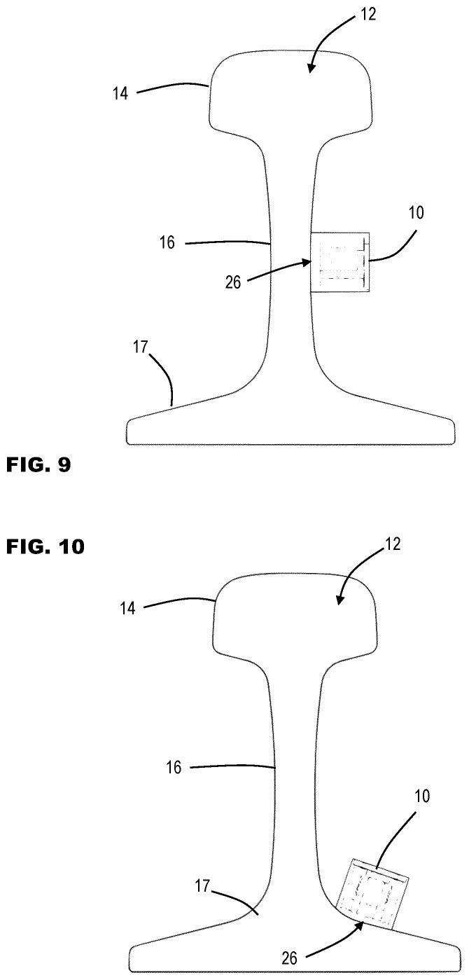

Other examples of contoured contact surface 26 of the sensing wall portion 22, for fitting against other regions of the rail profile, are illustrated in FIGS. 9 and 10. FIG. 9 illustrates a sensor unit 10 intended for fitting against the web 16 of a rail. The contoured contact surface 26 of the sensing wall portion 22 has a modest convex shape, optionally symmetrical for fitting near the centre of the web 16. FIG. 10 illustrates a sensor unit intended for fitting against the foot 17 of the rail 12. The contoured contact surface 26 of the sensing wall portion 22 has an asymmetric convex shape for fitting against the foot near the region where the foot thickens towards the web 14.

The choice of where on the rail profile it is desired to attach the sensor unit 10 may depend on the technical characteristics of the rail, and the information that is intended to be derived, directly or indirectly, from the signals obtained by the sensor unit 10.

Whatever the shape of the contact surface 26, the single-piece construction of the housing body can combine efficient coupling of the sensor unit 10 and the rail 12 for the signals to be detected by the sensor unit 10, with cost-efficient construction of the housing 18.

Optionally, the housing body 20 provides at least a majority, optionally at least 60%, optionally at least 70%, optionally at least 80%, optionally at least 90% of the contact surface portion(s) of the entire housing 18 for contacting the rail. In the illustrated example, substantially all of the contact surfaces of the housing 18 are provided by the housing body 20.

The housing body 20 optionally has an elongate tub shape. The housing body 20 is optionally open at an extremity, for example, opposite the sensing wall portion 22. In the illustrated form, the housing body 20 is open at its lower extremity and closed by a cover (not shown) also forming part of the housing 18. The housing body 20 optionally comprises bores 28 for receiving fixings (e.g. screws or bolts) for the cover. The housing body 20 may further comprise a cable port (e.g. aperture) 36, optionally in an end wall, through which a connecting cable may enter the sensor unit 10 for communicating with other off-sensor circuitry for processing. A portion 38 of the interior 24 may be allocated for a seal and/or strain relief grommet (not shown) for the cable.

The sensor unit 10 may be attached to the rail 12 by a variety of attachment techniques. In the illustrated example, magnets are provided (e.g. adhered) within the interior 24 of the housing body 20 adjacent to the sensing wall portion 22 at least for assisting temporary fixation during attachment until an adhesive has been cured. The magnets 36 may be positioned towards opposite end walls of the housing body 20. The magnets 36 enable the sensor unit 10 to be magnetically attracted, through the sensing wall portion 22, to the rail 12, for example, to the rail head 14. Providing magnets 40 within the interior compartment 24 of the housing body 20 can avoid the need for external mounting, or connecting apertures through the wall of the housing body 20, which may increase complexity and complicate hermetic sealing of the housing 18.

In one example, the sensor unit 10 may be adhesively attached to the rail 12. The magnetic attraction may be especially beneficial to hold the sensor in position while the adhesive cures, and to reinforce the adhesive attachment in use. Magnetic attraction to the underside of the rail head 14 (optionally in addition to magnetic attachment to the rail web 14) can resist any tendency for the sensor unit to slip downwardly compared, for example, to magnetic attachment to only the rail web 14. The large contact surface area of the housing body 20 and contoured contact surface 26 for fitting against the rail 12 may enable a relatively thin layer of adhesive to be used, reducing any signal loss in the adhesive itself. Also, when using adhesive, the surface of the rail may be treated (e.g. milled), to further enhance flatness and intimate fitting between the rail 12 and the housing body 20.

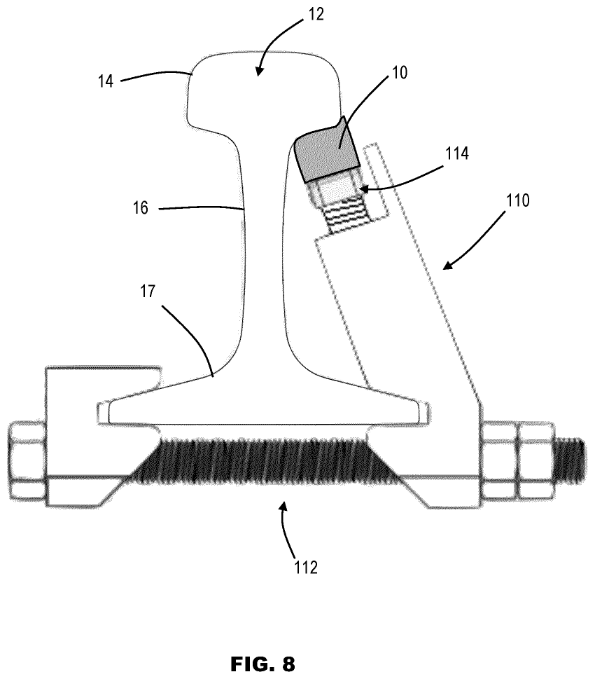

Additionally or alternatively to adhesive, the sensor unit 10 may be attached to the rail by a clamp 110 (FIG. 8). The clamp 110 may comprise a first clamp mechanism 112 for anchoring the clamp 110 to the rail, for example, to the foot 17, and a second clamp mechanism 114 for bearing against the sensor unit 10 to clamp the sensor unit 10 tightly against the rail 12. The clamp mechanisms 112 and 114 may, for example, comprises screw threaded clamp mechanisms. The magnetic attraction of the magnets may reinforce the attachment permanently or temporarily, e.g. until an attachment adhesive has been cured.

Alternatively, in other examples, the magnets 40 may provide the only or primary means of attachment of the sensor unit 10 to the rail.

Referring back to FIGS. 1 to 4, the housing body 20 may be of any material suitable for withstanding the rigour of a rail installation. A preferred material is stainless steel, which is strong with good corrosion resistance. Stainless steel may also have a very similar thermal expansion coefficient to that of the metal of the rail 12, which can reduce stress in the adhesive attachment as the temperature varies. Stainless steel may also provide a good acoustic impedance match for efficient transmission of the acoustic waves from the rail 12 into the housing body 20.

The sensor unit 10 further comprises at least one transducer 42 within the interior 24 of the housing body 20, for sensing the first physical parameter through attachment of the housing body to the rail. The transducer 42 is coupled to the sensing wall portion 22 of the housing body for receiving the first parameter signals through the housing body 20. The transducer 42 may be coupled (e.g. adhered) directly to the sensing wall portion 22, or it may be coupled to the sensing wall portion 22 via an intermediate element. In the present example, the transducer 42 is coupled to the sensing wall portion 22 via an electromagnetic shield 48a (described below). The transducer 42 is coupled (e.g. adhered) to the electromagnetic shield 48a which in turn is coupled (e.g. adhered) to the interior surface of the sensing wall portion 22. The coupling may be generally aligned on opposite sides of the electromagnetic shield 48a (e.g. in register) for a most direct coupling path to the transducer 42.

In the present example, first and second (e.g. two) transducers 42a and 42b are provided, operating in parallel with each other, generating respective signals. The transducers 42 may be independent units or they may share one or more components in common. For example, the transducers 42 may be piezo-electric transducers (e.g. based on a ceramic substrate and/or a crystal substrate) for sensing acoustic signals transmitted through the rail. Optionally, the first and second piezo-transducers 42 may share a common ceramic substrate and/or a common crystal substrate and/or share a common substrate electrode, while producing independent transducer signals. The first and second transducers 42 (a/b) may optionally have different acoustic sensitivities. The second transducer 42b may have a smaller sensitivity (ie. generate smaller signal amplitudes for the same acoustic signal) than the first transducer 42a. The sensitivities may, for example, be engineered by selecting the size of a respective signal electrode area on the substrate. A larger size of area increases the sensitivity. This can provide a technique for producing first and second transducers 42a/b on a common substrate, by dividing a signal electrode into two regions, optionally of different sizes.

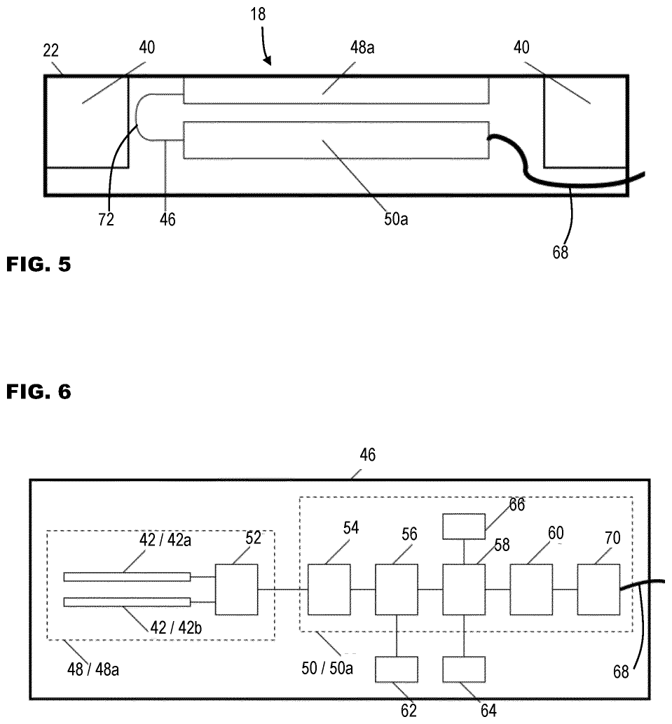

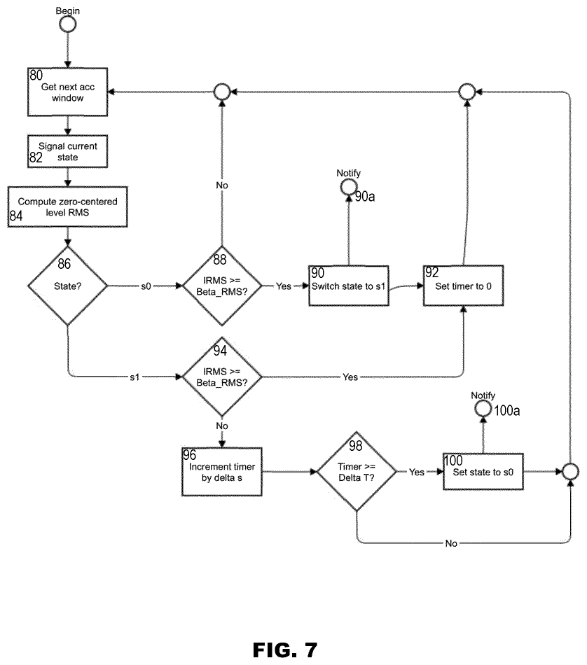

Referring to FIGS. 5 and 6, the transducers 42 and other electronic circuitry of the sensor unit 10 are carried on an at least partly flexible printed circuit substrate 46, optionally a rigid-flex printed circuit substrate 46. The circuitry is divided into two zones 48 and 50 of the substrate. The first zone 48 contains the transducers 42 and a dual-channel amplifier 52 located in the vicinity of the transducers for pre-amplifying the signals from the transducers 42 to a suitable line level for sending to the circuitry in the second zone 50.

The second zone 50 comprises a filter 54 for processing the amplified plural (e.g. dual) signals, an analog-to-digital converter (ADC) 56 for digitising the filtered signal, a local system controller 58, and a transceiver 60. The transceiver 60 is coupled to the output cable 68 via a surge protection circuit or element 70.

In addition to the piezo-electric transducers 42, the sensor unit 10 may comprise additional transducers. For example, one additional transducer may include an accelerometer 62 for sensing vibrations from the rail and/or vertical displacement of the rail as rolling stock passes overhead, and feeding a further signal to the ADC 56. Another additional transducer may include a temperature sensor 64 providing temperature information to the controller 58. Another additional transducer may include a three-dimensional accelerometer 66 coupled to the controller 58 and intended for sensing abnormal three-dimensional accelerations indicative of an abnormal occurrence, for example that the sensor unit 10 may have fallen off the rail 12 or that the rail 12 may have been displaced abnormally, for example, washed away, by a landslide. A warning signal may be generated via the transceiver 60 should abnormal acceleration be detected. Other techniques for detecting removal from the rail 12 may also be used, such as by emitting a small vibration pulse to the rail via an additional emitter (not shown) and listening for an echo from the rail wall.

As explained below, a feature of the present embodiment is high sensitivity for detecting even weak signals transmitted through the rail. Preferably, the filter 54 is preferably an active filter. Additionally or alternatively, the ADC 56 is a high performance type, such as a sigma-delta converter.

The first and second zones 48 and 50 of the circuit substrate 46 are each provided with respective electromagnetic shielding protection 48a and 50a mounted on the substrate 46. The shielding protection may have the form of a conductive casing enclosing the circuitry on the substrate to prevent electromagnetic interference and signal leakage, to comply with EMC requirements for a rail installation.

As explained above, each transducer 42 is coupled to the sensing (e.g. upper) wall portion 22 of the housing body via the electromagnetic shield (e.g. casing) 48a. Each transducer 42 is coupled (e.g. adhered) to the electromagnetic shield 48a on the circuit substrate 46, and the electromagnetic shield 48a in turn is coupled (e.g. adhered) to the interior surface of the sensing (e.g. upper) wall portion 22.

The region 72 of the circuit substrate 46 between the first and second zones 48 and 50 is flexible. The circuit substrate 46 is folded into a folded configuration with the zones 48 and 50 stacked in the interior compartment 24 of the housing body 20. The use of a rigid-flex circuit substrate can therefore enable cost-efficient manufacture of all of the sensor circuitry, including transducers and electromagnetic shielding, on a single printed circuit substrate, without needing any additional interconnection cables or connectors between different circuit elements, and efficient use of the interior space within the housing body 20. Provision of the electromagnetic shielding on the circuit substrate 46 can avoid the any need to build separate EMC compartments in the housing 18. This can reduce the costs of the housing 18, as well as simplify assembly of the circuitry to the housing.

During manufacture of the sensor unit 10, once the circuit substrate has been attached within the interior compartment 24 of the housing body 20, the interior space may be filled with a potting compound.

The sensor unit 10 includes circuitry having a controllable dynamic range configuration to enable both weak and strong occurrences of the physical parameter to be sensed from the rail.

The controllable dynamic range configuration includes at least: first configuration for handling a relatively weak occurrence of the physical parameter to be sensed by the transducer(s) 42, and a second configuration for handling a relatively strong occurrence. The configuration is controlled by the controller 58 in response to the current conditions detected by the sensor unit 10.

The illustrated example employs first and second transducers 42a and 42b of different sensitivity to the physical parameter. The first transducer 42a has a relatively high sensitivity. The second transducer 42b has a relatively low sensitivity. For the first configuration for relatively weak occurrences of the physical parameter, the circuitry uses the first transducer 42a or a signal derived therefrom. For the second configuration for relatively strong occurrences of the physical parameter, the circuitry uses the second transducer 42b or a signal derived therefrom.

The illustrated example also employs a dual-channel amplifier 52. A first channel (or first amplifier in the dual-channel amplifier) has a first gain, and a second channel (or second amplifier in the dual-channel amplifier) has a second gain different from the first. The first channel may receive a signal from the or a transducer 42 (e.g. first transducer 42a), and the second channel from the or a transducer 42 (e.g. second transducer 42b). The controller 58 may select between the first channel (e.g. first channel amplifier) and the second channel (e.g. second channel amplifier) for selecting the dynamic range configuration.

In a further example, the amplifier 52 may have a controllable dynamic range in the form of a controllable gain. The gain is settable selectively at (i) a first relatively high gain (corresponding to a first relatively small dynamic range) for weak signals, or (ii) a second relatively low gain (corresponding to a second relatively large dynamic range) for strong signals. When the signals from the transducer 42 are or are expected to be weak, the amplifier 52 is set to a high amplification gain to enable good discrimination of signal components compared to a noise floor. However, when the signals from the transducer 42 are or are expected to be strong, the amplifier is set to a low amplification gain to avoid saturation of the amplifier 52, filter 54 and ADC 56 by strong signals.

The controller 58 controls the dynamic range configuration in response to an envelope signal derived from the accelerometer 62 digitised by the ADC 56. The envelope signal may, for example, be derived from a calculated root mean square (RMS) value of samples taken over a sampling interval. The RMS signal may be a zero-centred level, e.g. the fixed or DC component of the signal is removed prior to the RMS level calculation.

FIG. 7 illustrates an example algorithm executable by the controller 58 to control the dynamic range configuration, with hysteresis to reduce risk of saturation or overloading. In FIG. 7, state s0 corresponds to the first configuration for relatively weak occurrences of the physical parameter to be sensed from the rail, and state s1 corresponds to the second configuration for relatively strong occurrences of the physical parameter to be sensed from the rail.

The algorithm comprises a repeating loop, with paths dependent on the current state s0 or s1, and on the envelope signal. At step 80, the signal from the accelerometer 62 is obtained. At step 82 the current control state (s0 or s1) is signalled to control the configuration state. At step 84, the envelope signal (e.g. zero-centre level RMS value) derived from the accelerometer signal is calculated. At step 86, the algorithm path branches depending on the current state.

If at step 86 the current state is s0 (first configuration), the algorithm branches through step 88 at which the envelope signal is compared to a threshold (e.g. a switching threshold “Beta RMS”). If at step 88 the envelope signal is less than the threshold, only weak or “non-saturating” signals are expected for detection by the sensor unit 10, and the algorithm returns to step 80. If at step 88 the envelope signal exceeds the threshold, a strong or “saturating” signal is expected. The algorithm proceeds to step 90 at which the state is switched to s1, and step 92 at which an interval timer is set to zero. Thereafter the algorithm returns to step 80, with the state set to s1.

If at step 86 the current state is s1 (second configuration), the algorithm proceeds to a hysteresis loop configured to maintain the state s1 until the envelope signal has dropped below the threshold and remained below the threshold for at least a predetermined interval “Delta T”. Step 94 first tests whether the envelope signal is above the threshold. If at step 94 the envelope signal exceeds the threshold, the algorithm proceeds to step 92 above and loops back to step 80. If at step 94 the envelope signal is below the threshold, the algorithm proceeds to step 96 at which the interval timer is incremented (by a value called “delta s”). At step 98, it is determined whether the interval timer has yet attained the value “Delta T”. If not, the algorithm loops back to step 80. If at step 98 the interval timer has attained the value “Delta T”, the predetermined interval has been reached, and the algorithm proceeds to step 100 at which the state is switched to s0 (first configuration). Thus, in order to switch from state s1 to s0, the algorithm must pass through steps 94 and 96 multiple times for the interval timer to increment sufficiently to reach “Delta T”. If at any time before the interval is complete the envelope exceeds the threshold, the algorithm is forced through step 92 to reset the interval timer to zero to restart timing the hysteresis interval.

It will be appreciated from the above that the algorithm has a rapid response in switching from state s0 (first configuration) to s1 (second configuration) when a strong or “saturating” signal is expected. In contrast, the algorithm has a slower response or a delayed response in switching back from state s1 (second configuration) to s0 (first configuration) until the signal has remained weak for at least the predetermined interval, and there is surety that only weak or “non-saturating” signal conditions are expected.

In the above algorithm, the state s0 or s1 switches only at steps 90 and 100. Optionally, a corresponding switching notification event or flag is triggered at steps 90a and 100a to indicate when a change in configuration state occurs.

The techniques and ideas described herein, illustrated by the preferred embodiment, can provide a rail sensor that is cost-efficient to manufacture, provides good coupling efficiency with a rail, and is able to detect signals accurately in both strong signal strength conditions and weak signal strength conditions.

The foregoing description is merely illustrative of a preferred form of the invention. Many modifications, equivalents and improvements may be made within the scope and/or principles of the invention.

1. A rail sensor unit for attachment to a rail of a rail track, the rail sensor unit being configured for sensing by attachment to the rail at least one physical parameter associated with objects interacting mechanically with the rail, the sensor unit comprising:
a housing comprising a housing body made in one piece, the housing body having a sensing wall portion with a contoured contact surface for fitting against at least a portion of a rail profile, and the housing body further comprising an interior compartment defined at least partly by the sensing wall portion;
a transducer in the interior compartment of the housing body and coupled to the sensing wall portion of housing body for sensing the parameter transmitted to the sensor unit through physical attachment of the housing to the rail; and
electronic processing circuitry in the interior compartment of the housing body for processing a signal from the transducer.

2. A rail sensor unit according to claim 1, wherein the contoured contact surface of the sensing wall portion of the housing body has a contour configured for fitting against one or more of: a head of a rail profile; a web of a rail profile; a foot of a rail profile.

3. A rail sensor unit according to claim 1, wherein the housing body has an open extremity, and wherein the housing further comprises a cover securable over the open extremity for closing the open extremity.

4. A rail sensor unit according to claim 1, wherein the housing body has an elongate tub shape, comprising the sensing wall portion having an elongate form, at least two elongate side walls extending from the sensing wall portion opposite one another, and at least two end walls extending from the sensing wall portion.

5. A rail sensor unit according to claim 1, wherein the contact surface of the sensing wall portion comprises a shoulder, and a ridge upstanding from the shoulder.

6. A rail sensor unit according to claim 5, wherein the ridge has a surface that is one or more of: inclined; bevelled.

7. A rail sensor unit according to claim 5, wherein the shoulder is configured for fitting against an underside of an undercut of the head of the rail, and the ridge is configured for fitting against a side edge of the head of the rail.

8. A rail sensor unit according to claim 5, wherein the housing body further comprises a side surface for at least one of facing towards and fitting against the web of the rail, and wherein a junction between the shoulder and the side surface has a non-square shape.

9. A rail sensor unit according to claim 1, wherein the contoured contact surface comprises one or more of: a generally symmetric convex surface; a generally asymmetric convex surface; a convex surface having a maximum height difference across the surface of no more than 30 mm; a surface having a non-square edge profile along at least one edge, the non-square profile selected from bevelled, chamfered, rounded.

10. A rail sensor unit according to claim 1, further comprising at least a first magnet positioned within the interior compartment of the housing body adjacent to the sensing wall portion for magnetically attracting the housing to a rail via the sensing wall portion.

11. A rail sensor according to claim 1, wherein the housing body provides substantially all of a contact surface of the housing for fitting against the rail.

12. A rail sensor unit according to claim 1, wherein the transducer is coupled to the sensing wall portion of the housing body via an intermediate member in the interior compartment.

13. A rail sensor unit for attachment to a rail of a rail track, for sensing by physical attachment to the rail at least one physical parameter associated with objects interacting mechanically with the rail, the sensor unit comprising a housing-, at least one transducer within the housing for sensing the parameter transmitted to the rail sensor through physical attachment to the rail, and electronic circuitry within the housing for receiving a signal from the at least one transducer, the electronic circuitry having a controllable dynamic range configuration settable in at least: (i) a first configuration for handling a relatively weak occurrence of the physical parameter to be sensed by the at least one transducer, and (ii) a second configuration for handling a relatively strong occurrence of the physical parameter to be sensed by the at least one transducer and wherein the electronic circuitry further comprises a controller for dynamically switching between the dynamic range configurations.

14. A rail sensor unit according to claim 13, wherein the at least one transducer comprises a first transducer having a first sensitivity to the physical parameter and generating a first signal, and a second transducer having a second sensitivity to the physical parameter and generating a second signal, the second sensitivity being smaller than the first sensitivity, and wherein the electronic circuitry comprises first and second input channels for the first and second signals.

15. A rail sensor unit according to claim 14, wherein the first and second transducers comprise first and second piezo-electric transducers generating the first and second signals.

16. A rail sensor according to claim 14, wherein the electronic circuitry is configured to select the first signal from the first transducer for the first configuration, and to select the second signal from the second transducer for the second configuration.

17. A rail sensor unit according to claim 13, wherein the controller is responsive to a magnitude of an envelope signal for dynamically selecting the dynamic range configuration.

18. A rail sensor unit according to claim 17, further comprising a further transducer within the housing, the envelope signal being generated from said further transducer, wherein the further transducer is configured (i) for sensing a second physical parameter associated with objects interacting mechanically with the rail, the second physical parameter different from the first physical parameter and/or (ii) for sensing the first physical parameter differently from the first transducer.

19. A rail sensor unit according to claim 18, wherein said further transducer is an accelerometer.

20. A rail sensor unit according to claim 13, wherein the electronic circuitry comprises one of (i) first and second signal amplifiers having respective different gains, wherein the controller is operable to select between the first and second amplifiers according to the respective dynamic range configuration and (ii), a signal amplifier having a controllable gain responsive to the dynamic range, wherein the controller is operable to set the gain of the variable gain amplifier according to the dynamic range configuration.

21. A rail sensor unit for attachment to a rail of a rail track, for sensing by physical attachment to the rail at least one parameter associated with objects interacting mechanically with the rail, the sensor unit comprising a housing, a transducer within and coupled to the housing for sensing the parameter transmitted to the rail sensor through physical attachment to the rail, and an at least partly flexible printed circuit substrate within the housing, the circuit substrate having a first zone on which is mounted the transducer and first electronic circuitry for receiving a signal from the transducer, and a second zone on which is mounted second electronic circuitry for processing a signal after processing by the first electronic processing circuitry, the circuit substrate having a folded configuration within housing.

22. A rail sensor unit according to claim 21, wherein the folded configuration is such that the first and second zones are stacked within the interior space of the housing.

23. A rail sensor unit according to claim 21, wherein the at least partly flexible circuit substrate is a rigid-flex printed circuit substrate.

24. A rail sensor according to claim 21, wherein the first electronic circuitry comprises a signal amplifier for amplifying an analog signal from the transducer.

25. A rail sensor according to claim 21, wherein a signal from the first electronic circuitry is transmitted to the second electronic circuitry via a flexible portion of the circuit substrate.

26. A rail sensor according to claim 21, further comprising first electromagnetic interference protection mounted on the circuit substrate for electromagnetically shielding the first zone of the circuit substrate, and second electromagnetic interference protection mounted on the circuit substrate for electromagnetically shielding the second zone of the circuit substrate.

27. A rail sensor according to claim 26, wherein the transducer is coupled to the housing via the first electromagnetic interference protection.

28. A combination comprising a rail sensor unit according to claim 1, and a rail to which the rail sensor unit is attached or is intended to be attached.

29. A method of operation in a rail sensor unit, the rail sensor unit configured for attachment to a rail of a rail track, for sensing by physical attachment to the rail at least one physical parameter associated with objects interacting mechanically with the rail, the sensor unit comprising a housing, at least one transducer within the housing for sensing the physical parameter transmitted to the rail sensor through physical attachment to the rail, and electronic circuitry within the housing for receiving a signal from the at least one transducer, the method comprising:
operating a controller to dynamically set a controllable dynamic range configuration of the electronic circuitry selectively between at least (i) a first configuration for handling relatively a weak occurrence of the physical parameter to be sensed by the at least one transducer, and (ii) a second configuration for handling a relatively strong occurrence of the physical parameter to be sensed by the at least one transducer.

30. A method according to claim 29, wherein the at least one transducer comprises a first transducer having a first sensitivity to the physical parameter, and a second transducer having a second sensitivity to the physical parameter smaller than the first sensitivity, and wherein the step of dynamically setting the controllable dynamic range configuration comprises selecting, for the first configuration, the first transducer or a signal therefrom, and selecting, for the second configuration, the second transducer or a signal therefrom.

31. A method according to claim 29, wherein the electronic circuitry comprises first and second amplifiers with respectively different gains, or an amplifier with variable gain, and wherein the step of setting a controllable dynamic range configuration comprises selecting between the first and second amplifiers or signals therefrom, or setting the gain level of the variable gain amplifier.

32. A method according to claim 29, wherein the step of setting comprises setting the controllable dynamic range configuration in response to a signal from a further transducer for sensing a second physical parameter different from the first physical parameter or for sensing the first physical parameter differently from the first transducer.

33. A method according to claim 32, wherein the first transducer is a piezo-electric transducer, and said further transducer is an accelerometer.

34. A rail sensor unit according to claim 3, wherein the open extremity is arranged opposite the sensing wall portion.

35. A rail sensor unit according to claim 5, wherein the shoulder is in the form of a plateau and wherein the ridge is upstanding from an edge of the shoulder.

36. A rail sensor unit according to claim 8, wherein the non-square shape is selected from bevelled, chamfered, rounded.

37. A rail sensor unit according to claim 9, wherein the rail sensor unit is configured for fitting against at least one of a web and a foot of a rail profile.

38. A rail sensor unit according to claim 10, wherein the rail sensor unit has a first and a second magnet.

39. A rail sensor unit according to claim 12, wherein the intermediate element is an element that is adhered between the transducer and the sensing wall portion.

40. A rail sensor unit according to claim 15, wherein the first and second piezo-electric transducers share a ceramic substrate or crystal substrate.
